(19) United States
(12) Patent Application Publication
(10) Pub. No.: US 2015/0028625 A1
(43) Pub. Date: Jan. 29, 2015

(54) BODY COMPONENT AND METHOD FOR PRODUCING A BODY COMPONENT

(71) Applicant: GM GLOBAL TECHNOLOGY OPERATIONS LLC, Detroit, MI (US)

(72) Inventor: Bernd Pohl, Muenster-Sarmsheim (DE)

(21) Appl. No.: 14/444,726

(22) Filed: Jul. 28, 2014

(30) Foreign Application Priority Data
Jul. 26, 2013 (DE) 102013012478.6

(51) Int. Cl. B62D 25/04; B62D 65/00

(52) U.S. Cl. CPC B62D 25/04; B62D 65/00
USPC 296/187.03; 29/897.2

(57) ABSTRACT

A body component, in particular a B-pillar, of a motor vehicle and method for producing same is disclosed. The body component includes a basic element and a multi-layered reinforcement element with at least two reinforcement element layers. The method includes positioning a first reinforcement element layer on the basic element, positioning a further reinforcement element layer on a side of the first reinforcement element layer facing away from the basic element, and materially joined connecting of the first reinforcement element layer to the basic element and the further reinforcement element layer.

### CROSS REFERENCE TO RELATED APPLICATION

This application claims priority to German Patent Application No. 102013012478.6 filed Jul. 26, 2013, which is incorporated herein by reference in its entirety.

### TECHNICAL FIELD

The technical field relates to a body component and a method for producing a body component, and in particular a B-pillar of a motor vehicle.

### BACKGROUND

Body components and in particular B-pillars in motor vehicles frequently require material reinforcements in certain regions mostly determined by possible force flows in anticipated crash situations. The distribution of the forces that occur at the B pillar in many instances requires different wall thicknesses along a body component, above all in the context of a necessary weight minimization.

When producing body components of metal sheets or similar semi-finished products, different approaches according to conventional practice are pursued for achieving different wall thicknesses. Thus, body components are assembled of a basic element and reinforcement elements. The reinforcement elements are arranged in those locations in which a greater wall thickness is required.

In particular when reinforcements of different wall thicknesses are necessary for a body component, expensive and/or elaborate pre-production or pre-assembly is frequently carried out in methods according to conventional practice for producing such body components.

### SUMMARY

The present disclosure provides an improved method for producing a body component, in particular a B-pillar, and an improved body component. The method for producing a body component, in particular a B-pillar, of a motor vehicle is proposed, wherein the body component includes a basic element and at least one multi-layered reinforcement element with at least two reinforcement element layers. In an embodiment, the method includes: positioning a first reinforcement element layer on or at the basic element; positioning a second or at least one further reinforcement element layer at or on a side of the first reinforcement element layer which faces away from the basic element; materially connecting, e.g. laser welding or resistance welding, the first reinforcement element layer to the basic element and the second reinforcement element layer. The steps of positioning can also be carried out multiple times and/or in a sequence other than stated. In addition or alternatively, the step of connecting can be carried out multiple times. As a result, a stepped reinforcement of the wall thickness of the body component, in particular locally adapted to expected force flows or force introductions can advantageously take place in an embodiment.

Additionally or alternatively a loss of strength of the first and/or at least one further reinforcement elements layer and the basic element and/or a further reinforcement element layer can thereby be advantageously reduced or avoided.

Additionally or alternatively a more cost effective, quicker, less error-prone and/or more simple production of the body component can thereby be achieved in an embodiment.

In the following, the present disclosure is described in the context of the B-pillar of a motor vehicle. The present disclosure can be equally applied with a multitude of body components, in particular with other pillars in the motor vehicle such as A-pillar or C-pillar.

A basic element of a body component here is to mean in particular an element of the body component by means of which the body component is connected to adjacent body components of the vehicle body. In particular, a basic element can be the element of the body component which in certain regions has a wall thickness which, because of the force introduction to be expected in operating situations and/or crash situations, is in need of reinforcement, in particular through a reinforcement element.

The basic element can also include multiple basic element parts which are connected or to be connected to one another directly or indirectly for example via at least one reinforcement element or one reinforcement layer, in particular consist thereof

According to an embodiment, a reinforcement element in particular is an element of the body component which will be or is connected in a materially joined manner to a basic element of the body component and is arranged in a region in which the wall thickness of the basic element with respect to the expected introduction of forces in operating situations and/or crash situations of the vehicle requires reinforcement. A reinforcement element in this case includes in particular at least two, and in other embodiments even three, four or more reinforcement element layers.

A reinforcement element layer in an embodiment is or will be produced from a metal sheet or a similar semi-finished product. When producing a body component or a reinforcement element layer used in a body component can have an at least substantial identical wall thickness or at least partly different wall thicknesses.

“Positioning” is intended to mean arranging of at least one element of the body component on at least one other element of the body component, in particular in a predetermined position of at least two elements of the body component relative to one another.

“Materially-joined connecting” or “materially connecting” is intended to mean in particular a joining of at least two, in particular of all elements of the body component by means of a welding method, in particular laser welding method. The materially joined connecting in this case can be carried out by means of a robot-guided, hand-guided and/or stationary laser processing head and/or with a spot welding tongs.

In order to advantageously improve or refine the adaptation of the wall thickness of the body component, for example to expected force flows or force introductions, at least one other further, one-third and/or one-fourth reinforcement element layer is positioned on a side facing away from a basic element, and directly preceding reinforcement element layer and connected with the latter in a materially joined manner, in particular by means of laser or resistance welding.

A “further” reinforcement element layer is intended to mean in particular a second reinforcement element layer which is directly arranged at or on the first reinforcement element layer on the side of the latter facing away from the basic element. Equally, a third reinforcement element layer, which on a side of the second reinforcement element layer facing away from the basic element is directly arranged at or on the latter, or a fourth or fifth or higher reinforcement element arranged analogously at or on the preceding reinforcement element layer can be a further reinforcement element layer.

A “preceding” reinforcement element layer refers to a reinforcement element layer which is nearer to the basic element at least in a part region of its extension surface. A “directly preceding” reinforcement element layer accordingly refers to the reinforcement element layer that is nearer to the basic element of the two reinforcement element layers contacting one another.

In order to advantageously achieve a more cost-effective, quicker, less error-prone and/or simpler production of the body component, the basic element and at least two reinforcement element layers according to a further development are connected to one another substantially at the same time and/or jointly, in particular by means of laser or resistance welding.

“Connected to one another” in an embodiment may mean that the basic element and all installed reinforcement elements or layers form a materially joined unit, wherein an element or an element layer can be connected at least indirectly (but not necessarily directly) to each other element or each other element layer.

In order to advantageously improve or refine the adaptation of the wall thickness of the body component to expected force flows or force introductions, the first reinforcement element layer according to a further development is positioned partly overlapping the basic element. Furthermore, at least one, in particular all further reinforcement element layers are positioned completely or only partly overlapping an in particular directly preceding reinforcement element layer.

“Partly overlapping positioning” is intended to mean that a further reinforcement element layer of the body component is positioned or will be positioned at or on a part of the entire surface or side facing it of a preceding reinforcement element layer or of a basic element contacting the latter. “Completely overlapping positioning” here is to mean that a further reinforcement element layer of the body component is positioned or will be positioned on the entire surface or side facing it of a preceding reinforcement element layer or of a basic element, in particular contacting this or these.

In terms of the present disclosure, two elements of the body component can also include more than one, in particular two or three pairs of surfaces or sides facing one another. According to an embodiment, both the basic element as well as at least one reinforcement element layer can be formed as profile with a cross section in the form of three edges arranged U-shaped so that in this case three pairs of surfaces facing one another occur.

The surfaces or sides facing one another within a pair in this case are at least substantially parallel to one another in particular in the region of their overlap. Different ones of these pairs are arranged relative to one another in particular at an angle that is different from 0°.

In particular, in order to advantageously achieve a more cost-effective, quicker, less error-prone and/or simpler production of the body component, a reinforcement element layer and the basic element and/or at least one further reinforcement element layer according to a further development are aligned with one another by at least one positioning device for the materially-joined connecting. A positioning device here can in particular include one or multiple positioning holes, recesses, arbors, flanges, webs, grooves, elevations and/or any other conventionally used positioning devices.

In particular, in order to advantageously achieve a more cost-effective, quicker, less error-prone and/or simpler production of the body component, at least two, in particular all reinforcement element layers according to a further development are produced or will be produced, in particular cut from semi-finished products, in particular metal sheets, at least of substantially identical wall thickness.

According to one embodiment, two, three, four or all reinforcement element layers will be or are produced from the same semi-finished product or metal sheet. In particular, in order to advantageously achieve a more cost-effective, quicker, less error-prone and/or simpler production of the body component, the basic element and, in particular all, reinforcement element layers according to a further development are pressed in particular jointly and/or substantially at the same time into a predetermined form, in particular by means of a single cold or hot forming step.

In particular, in order to advantageously achieve a more cost-effective, quicker, less error-prone and/or simpler production of the body component, the basic element and if applicable at least one multiple or all of the reinforcement element layers according to a further development are cut in a chip-less manner, in particular laser-cut for achieving a predetermined contour.

At least two, and preferably all reinforcement element layers and/or the at least one basic element can be connected together already formed or be connected, preferably welded as blank and jointly formed later on. Here, the elements or element layers can be cold-formed or hot-formed for improving the strength. In particular when hot forming of elements or element layers takes place, these elements or element layers include a steel that is suitable for this process such as for example PHS (press hardened steel).

In order to advantageously achieve a more cost-effective, quicker, less error-prone and/or simpler production of the body component, a method of connecting is carried out according to a further development with a tool, in particular a laser head and/or spot welding tongs. The method of severing may preferably be carried out by this same tool, namely a laser head. A laser head is intended to mean a laser processing tool for laser welding, laser cutting and/or other laser-based production and/or assembly steps. Here, a laser head for producing a body component in terms of the present disclosure can in particular be stationary, moved manually and/or in a robot-supported manner.

The features disclosed with respect to the aspect of the present disclosure described above and the associated further developments of the present disclosure accordingly apply also to the aspect of the present disclosure described in the following and the associated further developments of the body component. Conversely, the features disclosed with respect to the aspect of the present disclosure described in the following and the associated further developments of the body component accordingly also apply to the aspect of the present disclosure described above and the associated further developments of the method.

According to an aspect of the present disclosure, a body component of a motor vehicle, and in particular a B-pillar of a motor vehicle, is proposed including a basic element and a reinforcement element with a first reinforcement element layer positioned on the basic element and a further reinforcement element layer positioned at or on a side of the first reinforcement element layer facing away from the basic element. Here, the first reinforcement element layer is connected to the basic element and to the further reinforcement element layer in a materially joined manner. As a result, a stepped, locally varying reinforcement of the wall thickness of the body component which is adapted for example to expect force flows or force introductions can be carried out.

Additionally or alternatively, a more cost-effective, quicker, less error-prone and/or simpler production of the body component can be advantageously achieved in an embodiment. In order to advantageously improve or refine in particular the adaptation of the wall thickness of the body component, for example to expected force flows or force introductions, the reinforcement element according to a further development includes at least one, in particular two, three or four other further reinforcement element layers, which are positioned on a side of a preceding reinforcement element layer facing away from the basic element and are connected to this in a materially joined manner, in particular by laser or resistance welding.

In order to advantageously improve or refine the adaptation of the wall thickness of the body component, for example to expected force flows or force introductions, the first reinforcement element layer partly overlaps the basic element according to a further development. At least one and preferably each further reinforcement element layer completely or only partly overlap an in particular directly preceding reinforcement element layer in an embodiment.

In order to advantageously improve or refine the adaptation of the wall thickness of the body component, for example two expected force flows or force introductions, at least one reinforcement element layer according to a further development includes two or more parts which are spaced from one another, wherein these parts of the reinforcement element layer in an embodiment only partly overlap a preceding reinforcement element layer.

In order to advantageously achieve a more cost-effective, quicker, less error-prone and/or simpler production of the body component, at least two, and preferably three, four or all reinforcement element layers according to a further development have a substantially identical wall thickness. These reinforcement element layers are produced from semi-finished products such as metal sheets substantially of identical wall thickness.

According to an aspect of the present disclosure, a motor vehicle with a body component, in particular with a B-pillar, according to the previous aspect of the present disclosure or an associated further development is proposed.

### BRIEF DESCRIPTION OF THE DRAWINGS

The present disclosure will hereinafter be described in conjunction with the following drawing figures, wherein like numerals denote like elements.

FIG. 1 shows the elements of a B-pillar according to an embodiment of the present disclosure in a schematic top view;

FIG. 1b shows B-pillar with the elements of FIG. 1a according to an embodiment of the present disclosure in a schematic top view;

FIG. 2a shows the reinforcement element layers of a B-pillar according to an embodiment of the present disclosure in a top view;

FIG. 2b shows the B-pillar with the reinforcement element layers from FIG. 2a according to an embodiment of the present disclosure in a top view; and

FIG. 3a-c show different B-pillars according to different embodiments of the present disclosure each in a schematic sectional view.

### DETAILED DESCRIPTION

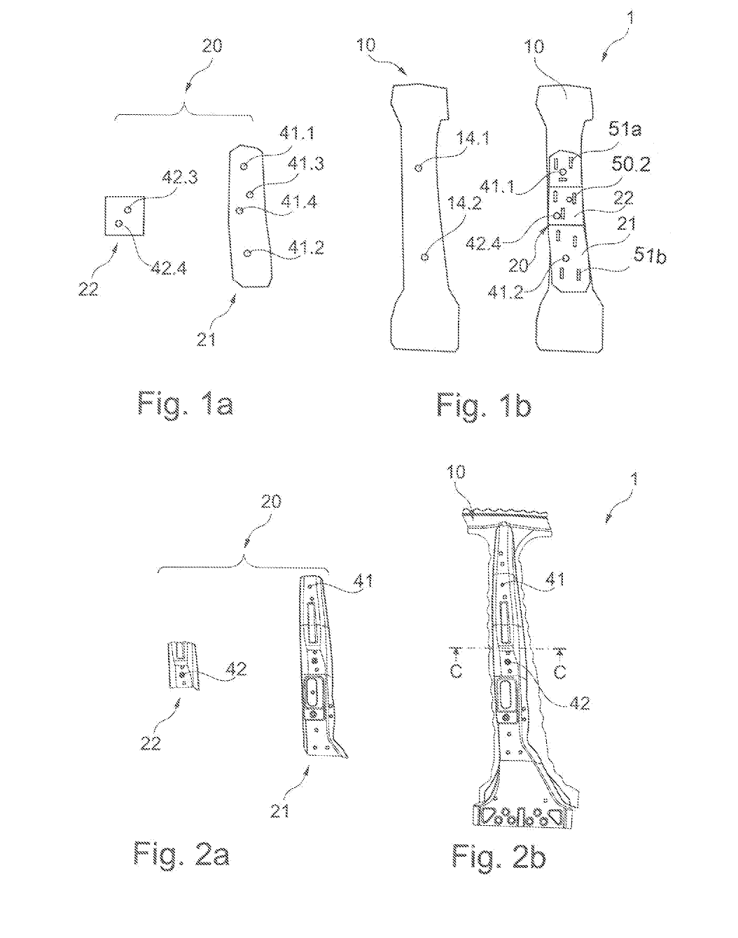

FIG. 1a shows the elements 10, 20 of a B-pillar 1 according to an embodiment of the present disclosure in a schematic top view. In this exemplary embodiment, these elements are the basic element 10, the first reinforcement element layer 21 of the reinforcement element 20 and the second reinforcement element layer 22 of the reinforcement element 20. In the representation of FIG. 1a, the elements 10, 21 and 22 are shown in the uninstalled state.

The basic element 10 includes positioning holes 14.1 and 14.2 which correspond or are congruent with the positioning holes 41.1 and 41.2 respectively of the first reinforcement element layer 21. The two elements 10 and 21 will be or are thus positioned or aligned relative to one another by means of these positioning holes.

The second reinforcement element layer 22 includes positioning holes 42.3 and 43.4 which correspond to or are congruent with the positioning holes 41.3 and 41.4 respectively of the first reinforcement element layer 21. The two elements 22 and 21 will be or are thus positioned or aligned relative to one another by means of these positioning holes.

The reinforcement element layers 21 and 22 and the basic element 10 in this exemplary embodiment are laser-welded as blanks and jointly formed in a subsequent step—which is not shown. Here, the elements or element layers 10, 21 and 22 can be cold formed or, more preferably hot formed for improving the strength. In particular, when hot forming of elements or element layers 10, 21 and 22 takes place, these elements or element layers 10, 21 and 22 include a steel suitable for this step such as for example PHS (press hardened steel), or consist of such.

FIG. 1b shows a B-pillar with the elements 10, 21 and 22 of FIG. 1a according to an embodiment of the present disclosure in a schematic top view. In the representation of FIG. 1b, the elements 10, 21 and 22 are shown in the state installed in or connected to the B-pillar 1.

The reinforcement element layers 21 and 22 will be or are positioned or aligned by means of the positioning holes 14, 41 and 42 on one another and on the basic element and following this each with a laser welding bead connected to one another in a materially joined manner at the laser welding points 50.2 and 51a and 51b and the other laser welding points which are shown in FIG. 1b however not in inverted commas

Each of the laser welding beads 50.2 is or will be carried out passing through the second reinforcement element layer 22, the first reinforcement element layer 21 and the basic element 10 and thereby connects these three elements 10, 21 and 22.

The first reinforcement element layer 21 is arranged so that it partly overlaps the basic element 10. As a result, the B-pillar in this first overlap region has a greater absorption capability for forces or moments introduced laterally or in the event of a side impact/crash.

The second reinforcement element layer 22 is arranged so that it partly overlaps the first reinforcement element layer 21. As a result, the B-pillar 1 in this second overlap region has a further elevated absorption capability for forces or moments introduced in particular laterally or in the case of a side impact/crash.

FIG. 2a shows the reinforcement element layers 21 and 22 of the reinforcement element 20 of a B-pillar 1 according to an embodiment of the present disclosure in a top view. The reinforcement element layers 21 and 22 and the basic element 10 in this embodiment are laser-welded already formed. The prior step of forming is not shown in FIG. 2a. The elements or element layers 10, 21 and 22 in this case can be cold formed or, in particular to improve the strength, hot-formed. In particular when hot forming of elements or element layers 10, 21 and 22 takes place, these elements or element layers 10, 21 and 22 include a steel that is suitable for this process such as for example PHS (press hardened steel) or consist thereof

FIG. 2b shows a B-pillar 1 with the reinforcement element layers 21 and 22 of the reinforcement element 20 from FIG. 2a according to an embodiment of the present disclosure in a top view. In FIG. 2b, the B-pillar 1 is shown after its elements 10, 21 and 22 have been pressed into a predetermined form. In the present exemplary embodiment, this can take place jointly or separately and/or before or after the welding.

A step of laser cutting the B-pillar 1 that may have to be carried out on the basis of a predetermined contour has not, at least not yet, taken place.

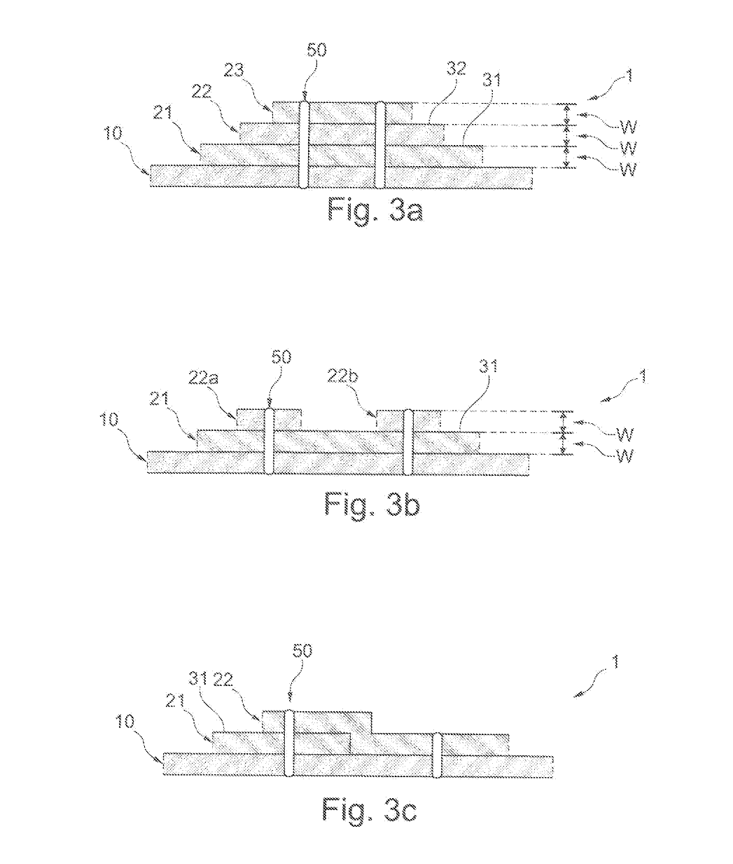

FIG. 3a-c show different B-pillars 1 according to different embodiments of the present disclosure each in a schematic sectional view in a section running analogous to the section C-C drawn in in FIG. 2b, wherein FIG. 2b shows an embodiment of the present disclosure which differs from the embodiments shown in FIG. 3a-c.

FIG. 3a shows a section through a B-pillar 1 according to an embodiment of the present disclosure, which in addition to the basic element 10 includes a first reinforcement element layer 21, a second reinforcement element layer 22 and a third reinforcement element layer 23. Here, the second reinforcement element layer 22 is arranged on the side 31 of the first reinforcement element 21 facing away from the basic element, the third reinforcement element layer 23 on the side 32 of the second reinforcement element layer 22 facing away from the basic element. The elements 10, 21, 22 and 23 are connected to one another at the laser welding points 50—partly indirectly, partly directly. The reinforcement element layer 21, 22 and 23 each have an at least substantially identical wall thickness W, in particular because they are cut from the same metal sheet. Because of this, a more cost-effective, quicker, less error-prone and/or simpler production of the B-pillar 1 can be achieved.

FIG. 3b shows a section through a B-pillar 1 according to an embodiment of the present disclosure, which includes a basic element 10 and a first reinforcement element layer 21. On the side 31 of the first reinforcement element layer 21 facing away from the basic element a second reinforcement element layer 22 will be or is positioned, i.e. aligned or arranged, which includes two parts 22a and 22b which are spaced from one another. Thus, a same type of reinforcement of the B-pillar 1 in regions of the B-pillar 1 which are spatially spaced from one another can take place.

FIG. 3c shows a section through a B-pillar 1 according to an embodiment of the present disclosure, wherein the second reinforcement element layer 22 is positioned on the side 31 of the first reinforcement element layer 21 facing away from the basic element only in a part region of its extension. In a further part region of its extension, the second reinforcement element layer 22 is directly positioned on the basic element 10 and also connected on a laser welding point to the latter.

Although in the preceding description exemplary embodiments were explained it is pointed out that a multitude of modifications is possible. It is pointed out in addition that the exemplary embodiments are merely examples which are not intended to restrict the scope of protection, the applications and the construction in any way. The preceding description rather serves to provide the person skilled in the art with a guideline for implement at least one exemplary embodiment, wherein various changes, in particular with respect to the function and arrangement of the described components can be carried out without leaving the scope of protection as obtained from the claims and feature combinations equivalent to these.

1-15. (canceled)

16. A method for producing a body component of a motor vehicle comprising:
providing a basic element;
positioning a first reinforcement element layer on the basic element;
positioning a second reinforcement element layer on a side of the first reinforcement element layer opposite the basic element; and
connecting the first reinforcement element layer to the basic element and to the second reinforcement element layer in a materially joined manner.

17. The method according to claim 1, further comprising positioning a third reinforcement element layer on a side of the second reinforcement element layer opposite the basic element, and connecting the third reinforcement later to the second reinforcement element layer in a materially joined manner.

18. The method according to claim 16, wherein connecting comprises laser welding the first reinforcement element layer to the basic element and the second reinforcement element layer to the first reinforcement element layer in a materially- joined manner.

19. The method according to claim 16, wherein connecting comprises resistance welding the first reinforcement element layer to the basic element and the second reinforcement element layer to the first reinforcement element layer in a materially- joined manner.

20. The method according to claim 16, wherein positioning the first reinforcement element layer comprised positioning the first reinforcement element layer to partly overlap the basic element, positioning the second reinforcement element layer at least partly overlapping the first reinforcement element layer.

21. The method according to claim 16, further comprising aligning the basic element and at least one of the first and second reinforcement element layers with at least one positioning device.

22. The method according to claim 16, further comprising cutting the first and second reinforcement element layers from metal sheets of at least substantially identical wall thickness (W).

23. The method according to claim 16 further comprising jointly press forming the basic element and the reinforcement element layers into a predetermined form.

24. The method according to claim 16, further comprising laser cutting the first and second reinforcement element layers from metal sheets.

25. The method according to claim 24, wherein the process of laser cutting and connecting the basic element and the first and second reinforcement element layers is carried out by a laser head.

26. A body component of a motor vehicle comprising:
a basic element
a reinforcement element having a first reinforcement element layer positioned on the basic element and a second reinforcement element layer positioned on a side of the first reinforcement element layer opposite the basic element,
wherein the first reinforcement element layer is connected to the basic element and to the second reinforcement element layer in a materially joined manner.

27. The body component according to claim 26, wherein the reinforcement element further comprises a third reinforcement element layer positioned on a side of a second reinforcement element layer opposite the basic element and connected thereto in a materially joined manner.

28. The body component according to claim 26, wherein the first reinforcement element layer partly overlaps the basic element and the second reinforcement element layer at least partly overlaps the first reinforcement element layer.

29. The body component according to claim 26, wherein at least one of the first and second reinforcement element layers comprises at least two parts are spaced from one another, and wherein the at least two parts partly overlap a preceding reinforcement element layer.

30. The body component according to claim 26, wherein the first and second reinforcement element layers and are produced metal sheets of substantially identical wall thickness (W).

31. A motor vehicle with a body component in the form of a B-pillar according to claim 26.
